(19) United States
(12) Patent Application Publication
(10) Pub. No.: US 2012/0058044 A1
(43) Pub. Date: Mar. 8, 2012

(54) PROCESS OF USING AN IMPROVED FLUE IN A TITANIUM DIOXIDE PROCESS

(75) Inventor: Charles David Musick, Waverly, TN (US)

(73) Assignee: E.I. DU PONT DE NEMOURS AND COMPANY, Wilmington, DE (US)

(21) Appl. No.: 13/266,786

(22) PCT Filed: May 7, 2010
(86) PCT No.: PCT/US10/33998

§ 371 Date: Oct. 28, 2011

Related U.S. Application Data
(60) Provisional application No. 61/176,537, filed on May 8, 2009.

(51) Int. Cl. C01G 23/07; F28F 21/00

(52) U.S. Cl. 423/613; 165/180

(57) ABSTRACT

This disclosure relates to a flue providing improved heat transfer comprising an inner layer and an outer layer, wherein the inner layer comprises a high thermal conductivity ceramic having a thermal conductivity of at least 91 W/m-K (@300K) and a Moh's hardness of at least 6.5, and comprises a plurality of protuberances 13, depressions 14 or both; and wherein the inner layer 12 and the outer layer 11 are in substantially continuous, thermally conductive contact. Titanium dioxide particles having improved particle size, gloss, undertone, tinting strength and hiding power are famed using the above described flue.

### BACKGROUND OF THE DISCLOSURE

1. Field of the Disclosure

The present disclosure relates to a process for cooling titanium dioxide that is manufactured, and in particular to a flue having protuberances or depressions that achieves more efficient cooling of the titanium dioxide particles.

2. Background of the Disclosure

Titanium dioxide pigments have a variety of applications, including coatings, paints, plastics, paper, etc. Light scattering is one of the important properties of these pigments and it is very dependant on particle size and on particle size distribution.

Substantial quantities of titanium dioxide pigment are produced commercially by reacting titanium tetrachloride with oxygen in the vapor phase. Immediately after such reaction, the titanium dioxide reaction mass is cooled by passing it through a conduit, i.e., flue, where growth of the titanium dioxide pigment particles and agglomeration of said particles takes place.

It is desirable to cool the titanium dioxide rapidly because this will result in pigment having higher carbon black undertone (“CBU”). CBU is described in U.S. Pat. No. 2,488,440, which is hereby incorporated by reference. However, when a smaller diameter flue is used to permit more rapid cooling, it has been found that while CBU is increased, turbulence can be increased, which increases agglomeration of the pigment particles and thereby decreases pigment gloss.

A need exists for an improved flue that effectively provides the necessary cooling of the titanium dioxide particles without the deficiencies of known flues.

### SUMMARY OF THE DISCLOSURE

In a first aspect, the disclosure provides a flue providing improved heat transfer comprising an inner layer and an outer layer, wherein the inner layer comprises a high thermal conductivity ceramic having a thermal conductivity of at least 91 W/m-K (@300K) and a Moh's hardness of at least 6.5, and comprises a plurality of protuberances, depressions or both; and wherein the inner layer and the outer layer are in substantially continuous, thermally conductive contact.

In the first aspect this substantially continuous, thermally conductive contact is achieved by compression fitting; electrodeposition, use of a conductive adhesive layer, or casting with a molten metal.

In a second aspect, the disclosure provides a process for preparing titanium dioxide particles having improved particle size distribution and/or undertone comprising:
a. reacting titanium tetrachloride and oxygen to form titanium dioxide particles; and
b. cooling said particles in a flue, wherein the flue providing improved heat transfer comprises an inner layer and an outer layer, wherein at least a portion of the inner layer comprises a high thermal conductivity ceramic having a thermal conductivity of at least 91 W/m-K (@300K) and a Moh's hardness of at least 6.5, and comprises a plurality of protuberances, depressions or both; and wherein the inner layer and the outer layer are in substantially continuous, thermally conductive contact.

### BRIEF DESCRIPTION OF THE DRAWINGS

FIG. 1 illustrates and end view of the flue utilized in this disclosure.

### DETAILED DESCRIPTION OF THE DISCLOSURE

The process for producing titanium dioxide pigment by reacting oxygen and titanium tetrachloride in the vapor phase is disclosed, for example, in U.S. Pat. Nos. 2,488,439, 2,488,440, 2,559,638, 2,833,627, 3,208,866, and 3,505,091. The disclosures of such patents are hereby incorporated by reference.

Such reaction usually takes place in a pipe or conduit, wherein oxygen and titanium tetrachloride are introduced at a suitable temperature and pressure for production of the titanium dioxide. In such a reaction, a flame is generally produced.

Downstream from the flame, the titanium dioxide produced is fed through an additional length of conduit wherein cooling takes place. For the purposes herein, such conduit will be referred to as the flue. The flue should be as long as necessary to accomplish the desired cooling. Typically, the flue is water cooled and can be about 50 feet (15.24 m) to about 3000 feet (914.4 m), typically about 100 feet (30.48 m) to about 1500 feet (457.2 m), and most typically about 200 feet (60.96 m) to 1200 feet (365.76 m) long. The length of the flue of the disclosure can be same or less than the total length of the flue disclosed above.

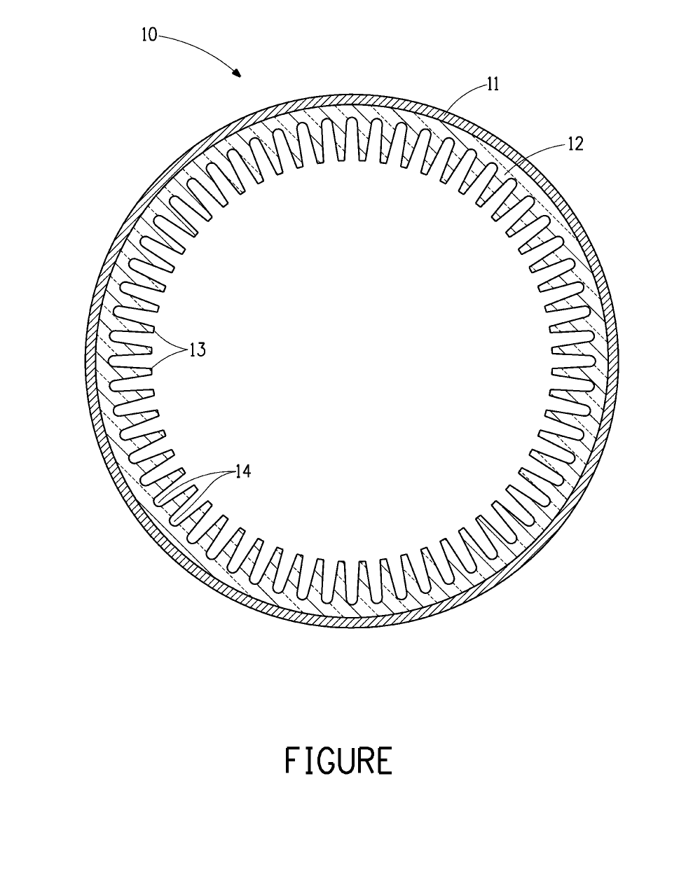

The flue used in this disclosure can be any suitable shape which does not cause excessive turbulence. Typically, the flue will be round, i.e., in the form of a pipe. The flue 10 providing improved heat transfer, shown in FIG. 1, comprises an inner layer 12 comprising a high thermal conductivity ceramic having a thermal conductivity of at least 91 W/m-K (@300K), and a Moh's hardness of at least 6.5 and comprises protuberances 13, depressions 14 or both, and an outer layer 11 that is in substantially continuous, thermally conductive contact with the inner layer 12.

The inner layer 12 comprising protuberances 13, depressions 14 or both, is made of a highly thermal conductive ceramic material having a thermal conductivity of at least about 91 W/m-K (@300K, more typically about 110 to about 150 W/m-K (@300K , and a Moh's hardness of at least 6.5, typically about 9 to about 9.5. Using a material of construction with a Moh's hardness greater than 6.5 increases the life of the flue and reduces the TiO2 product contamination from the erosion products. Typically the material used for the inner layer 12 is also chlorine resistant. Some suitable examples of high thermal conductivity ceramic materials include aluminum nitride, sintered a silicon carbide and other forms of silicon carbide. More typically, the protuberances may be fins or ridges.

Typically the inner layer comprises as many protuberances 13, depressions 14 or combinations of both as possible. However, if there are too many the close spacing can cause entrapment of the pigment particles or scouring material between them. The shape and dimensions of the protuberances 13, such as fins, and depressions 14, are limited by the material of construction. A material with a higher thermal conductivity and better corrosion resistance allows additional longer, narrower fins to be installed in a flue. As such, a material like sintered alpha silicon carbide would allow more overall surface area on the internal portion of the flue due to the presence of additional longer, narrower fins. This would result in an improvement in the overall heat flux per unit of flue. The improved heat flux in the flue allows faster cooling of the TiO2 mass resulting in smaller particle size which is useful in the commercial manufacture of TiO2. U.S. Pat. No. 4,937,064 covers the impact on particle size and quality of the faster cooling and is incorporated herein as reference.

Generally, the protuberances 13 and/or depressions 14 can be substantially longitudinal, i.e., located along the length of the flue. By the term “substantially longitudinal” is meant that the protuberances 13 and/or depressions 14 should be substantially parallel (i.e., parallel to the axis of the conduit) or somewhat angled, (i.e., similar to the grooves in a rifle barrel). Typically, protuberances 13 and/or depressions 14 will be substantially parallel. With regard to the height of the fins, they typically can be as high as possible to enhance cooling, but not so high that they seriously erode (due to a high tip temperature) or cause increased turbulence.

Typically, a flue will contain enough fins to increase the amount of heat transfer from the process to the cooling water. Typically, a flue will have between 0.5 and 8 fins/inch of flue diameter, more typically between 1 and 5 fins/inch of flue diameter, and most typically between 2 and 4 fins/inch of flue diameter.

The outer layer 11 of the flue may be any substance that has good heat transfer properties, and good mechanical properties for construction and holding pressure. It comprises a metal selected from the group consisting of nickel, such as Nickel 200, which is a commercially pure wrought nickel having a minimum of about 99% nickel, nickel alloy, and various grades of stainless steel. Some suitable nickel alloys sold under the trade name Inconel® include alloy 600 described as UNS N06600, alloy 601 (UNS N06601), alloy 625 (UNS N06625), alloy 690 (UNS N06690). Some suitable nickel alloys sold under the trade name Hastelloy® include alloy G3/G30 (UNS N06030), Alloy C-22 (UNS N06022), Alloy C-276 (UNS N10276), Alloy X (UNS N06002). In general, the outer layer should be of adequate thickness to provide the needed mechanical strength for the pressure rating of the pipe, yet not of excessive thickness which would reduce heat transfer.

Because the improved flue used in this disclosure can be more expensive than an ordinary flue, typically, only a portion of the flue will have protuberances 13, depressions 14 or both. Also, because most of the cooling of the TiO2 will take place in close proximity to the flame of the titanium dioxide reaction, typically, the improved flue used in this disclosure will be used substantially immediately downstream of the reaction flame, and continue thereafter until the point is reached where substantially all or most of the growth and/or agglomeration of the pigment particles ceases. Typically, the length of the improved flue used in this disclosure can be about 5 feet (152.4 cm) to about 500 feet (152.4 m), more typically about 5 (152.4 cm) to about 300 feet (91.4 m), and most typically about 5 (152.4 cm) to about 100 feet (30.5 m). If desired, however, all or most of the flue can be the improved flue used in this disclosure; and, if so, this can decrease the required length of the flue because of the more efficient cooling it provides.

Typically, the tips of the protuberances 13 should be thinner than the base of the protuberances 13; more typical are protuberances 13 of a trapezoidal shape where the spaces between the protuberances 13 are depressions 14 that are rounded. Typically, the protuberances 13 are tapered, i.e., the inlet and outlet portions of the flue will have a protuberance height less than that at the highest point of the protuberances 13; especially typical are protuberances 13 which are tapered and flush or close to flush, i.e. the inner layer is substantially smooth, at the inlet and outlet of the flue.

The interior diameter of the improved flue of this disclosure should be that which does not in itself cause substantial turbulence with the velocity and other conditions for the TiO2 and other materials in the flue. Typical interior diameters are about 2 to about 50 inches (about 5 to about 127 cm), more typically about 5 to about 30 inches (about 13 to about 76 cm), and most typically about 6 to about 20 inches (about 15 to about 51 cm). Typically, the improved flue of this disclosure will have a conduit interior diameter which is greater than that of the ordinary flue which is located upstream from the improved flue of this disclosure. In the foregoing and as elsewhere used herein, (a) “interior diameter” means the distance between the two lowest points in the flue which are opposite each other, and (b) “upstream” or “downstream” are in reference to the flow of titanium dioxide pigment through the flue. typically, the diameter of the improved flue of this disclosure, when measured from tip to tip of protuberances 13 which are opposite each other, will be greater than or approximately equal to the diameter of the ordinary flue which is located upstream from the improved flue of this disclosure.

The inner layer 12 and the outer layer 11 are in substantially continuous, thermally conductive contact. By ‘substantially continuous, thermally conductive contact’ it is meant that the heat transfer is not adversely affected by air voids between the two layers. This substantially continuous, thermally conductive contact can be achieved by compression fitting; electrodeposition, use of a conductive adhesive layer, or casting with a molten metal. By providing a substantially continuous, thermally conductive contact, the silicon carbide temperature can be maintained below 900 C even when the reactor flue gas exceeds 1500 C.

In one specific embodiment, for a pipe containing a thermally conductive ceramic such as sintered alpha-silicon carbide, it is necessary to maintain good contact between the surface of the thermally conductive ceramic adjacent the pipe and the inner surface of the external cylindrical metal pipe. Failure to achieve good contact between the inner layer of thermally conductive ceramic and outer layer comprising metal can result in an air void which serves as an insulating layer. This air void insulating layer can allow the silicon carbide temperature to exceed 900 C resulting in failure of the silicon carbide due to chlorination. Good contact can be achieved by compression fitting of the inner layer (12) of thermally conductive ceramic into the outer layer (11) such as a pipe. Compression fitting can be achieved by heating the external metal pipe (11) causing it to expand. When the external pipe is heated and the metal expands the internal diameter of the pipe increases. While the pipe is hot, the cold thermally conductive ceramic cylindrical piece (12) can be inserted into the pipe (11). As the metal cools, it will contract and have a tight connection between the internal thermally conductive ceramic and outer layer of metal.

Another method of providing a compression fitting involves a welding procedure. Metals such as Nickel 200, that is a commercially pure wrought nickel having a minimum of about 99% nickel, will contract during welding. The compression fitting process is started with the inner layer comprising a thermally conductive ceramic piece snugly installed in an outer layer comprising a nickel pipe that is missing the longitudinal weld. As the longitudinal weld is installed, the pipe diameter will reduce allowing a compression fitted ceramic in nickel pipe.

Another method for ensuring a substantially continuous, thermally conductive contact would be the installation of a thermally conductive adhesive layer between the inner ceramic (12) and external metal pipe (11). The thermally conductive adhesive should fill the air voids between the two materials to allow high heat flux. It should also be heat resistant. Numerous high temperature thermally conductive adhesives are available commercially. Examples of these include but are not limited to aluminum nitride filled, silver filled, and nickel filled inorganic pastes.

Another method would be casting with molten metal. In this embodiment, the final ceramic finned piece that functions as the inner layer (12) could be cast with the molten metal on the exterior of the ceramic in a cylindrical tube mold to generate the external metal pipe that would function as the outer layer (11). The casting would allow the elimination of air voids between the ceramic and metal.

### EXAMPLES

### Example 1

Computational fluid dynamic (CFD) modeling of a fin fabricated from Nickel 200 was modeled with a set boundary condition for heat transfer from the process to the fin. The CFD modeling showed a heat flux of 29,187 watts/fin. The material of construction of the fin was changed to alpha silicon carbide while maintaining the boundary conditions for heat transfer from the process to the fin. With alpha silicon carbide, the heat transfer increased to 30,607 watts/fin. Depending upon the boundary layer conditions chosen for each case, the overall unit heat flux may change, however, the alpha silicon carbide piece will provide better heat transfer than Nickel 200.

What is claimed is:

1. A flue providing improved heat transfer comprising an inner layer and an outer layer, wherein the inner layer comprises a high thermal conductivity ceramic having a thermal conductivity of at least 91 W/m-K (@300K) and a Moh's hardness of at least 6.5, and comprises a plurality of protuberances, depressions or both; and wherein the inner layer and the outer layer are in substantially continuous, thermally conductive contact.

2. The flue of claim 1 wherein the substantially continuous, thermally conductive contact is achieved by compression fitting.

3. The flue of claim 1 wherein the substantially continuous, thermally conductive contact is achieved by electrodeposition.

4. The flue of claim 1 wherein the substantially continuous, thermally conductive contact is achieved by using a conductive adhesive layer.

5. The flue of claim 1 wherein the substantially continuous, thermally conductive contact is achieved by casting with a molten metal.

6. The flue of claim 1 wherein the high thermal conductivity ceramic is a sintered a silicon carbide.

7. The flue of claim 1 wherein the outer layer is selected from the group consisting essentially of nickel, nickel alloy and stainless steel.

8. The flue of claim 1 wherein the inner layer comprises protuberances.

9. The flue of claim 1 wherein the flue is installed wherein flue gas temperatures exceed 900° C.

10. The flue of claim 8 wherein the protuberances are fins.

11. The flue of claim 8 wherein the protuberances are ridges.

12. The flue of claim 10 wherein the fins are rifled in the inner layer.

13. A process for preparing titanium dioxide particles having improved particle size distribution and/or undertone comprising:
a. reacting titanium tetrachloride and oxygen to form titanium dioxide particles; and
b. cooling said particles in a flue, wherein the flue providing improved heat transfer comprises an inner layer and an outer layer, wherein at least a portion of the inner layer comprises a high thermal conductivity ceramic having a thermal conductivity of at least 91 W/m-K (@300K) and a Moh's hardness of at least 6.5, and comprises a plurality of protuberances, depressions or both; and wherein the inner layer and the outer layer are in substantially continuous, thermally conductive contact.

14. The process of claim 13 wherein the substantially continuous, thermally conductive contact is achieved by compression fitting.

15. The process of claim 13 wherein the substantially continuous, thermally conductive contact is achieved by electrodeposition.

16. The process of claim 13 wherein the substantially continuous, thermally conductive contact is achieved by using a conductive adhesive layer.

17. The process of claim 13 wherein the substantially continuous, thermally conductive contact is achieved by casting with a molten metal.

18. The process of claim 13 wherein the high thermal conductivity ceramic is a sintered a silicon carbide.

19. The process of claim 13 wherein the outer layer is selected from the group consisting essentially of nickel, nickel alloy and stainless steel.

20. The process of claim 13 wherein the inner layer comprises protuberances.

21. The process of claim 13 wherein the flue is installed wherein flue gas temperatures exceed 900° C.

22. The process of claim 13 wherein the flue is installed wherein flue gas temperatures exceed 1200° C.

23. The process of claim 20 wherein the protuberances are fins.

24. The process of claim 23 wherein the fins are rifled in the inner layer.

25. The process of claim 13 wherein the entire length of the flue comprises an inner layer and an outer layer, wherein the inner layer comprises a high thermal conductivity ceramic having a thermal conductivity of at least 91 W/m-K (@300K) and a Moh's hardness of at least 6.5, and comprises protuberances, depressions or both; and wherein the inner layer and the outer layer are in substantially continuous, thermally conductive contact.
